(19) United States
(12) Patent Application Publication
(10) Pub. No.: US 2024/0173800 A1
(43) Pub. Date: May 30, 2024

(54) LASER WELDING METAL FOIL STACK TO METAL SUBSTRATE

(71) Applicant: Rofin-Sinar Laser GmbH, Hamburg (DE)

(72) Inventors: Falk NAGEL, Bad Oldesloe (DE); Peter KALLAGE, Hamburg (DE)

(73) Assignee: Rofin-Sinar Laser GmbH, Hamburg (DE)

(21) Appl. No.: 18/277,266

(22) PCT Filed: Jan. 7, 2022
(86) PCT No.: PCT/EP2022/050270

§ 371 Date: Aug. 15, 2023

Related U.S. Application Data
(60) Provisional application No. 63/152,534, filed on Feb. 23, 2021.

(51) Int. Cl. B23K 26/26; B23K 26/073; B23K 26/10; B23K 37/04; B23K 101/36; B23K 103/10

(52) U.S. Cl. CPC B23K 26/26; B23K 26/0734; B23K 26/10; B23K 37/0435; B23K 2101/36; B23K 2103/10

(57) ABSTRACT

A method for laser welding a stack of metal foils to a metal substrate includes securing the stack of metal foils between a surface of the metal substrate and a removable clamp such that a side of the stack, formed by edges of the foils, is located on an interior portion of the surface, and the clamp is set back from the side of the stack. A first laser welding step interconnects the foils with an initial laser-weld joint by serially tracing a plurality of lateral paths along the foil edges with a laser beam. A second laser welding step connects the stack of interconnected foils to the substrate by tracing, with a laser beam, a path along the interface between the initial laser-weld joint and the substrate surface. This two-step laser welding process circumvents the difficulties of welding together materials with highly disparate thicknesses in a single laser-welding operation.

### CROSS-REFERENCE TO RELATED APPLICATIONS

This application is a U.S. national stage application under 35 U.S.C. § 371 of International Application No. PCT/EP2022/050270, filed Jan. 7, 2022, which claims the benefit of U.S. Provisional Application No. 63/152,534, filed Feb. 23, 2021, the entire contents of each priority application is incorporated herein by reference.

### FIELD OF THE DISCLOSURE

The present invention relates in general to laser welding of a stack of metal foils to a metal substrate, in particular as applied to the production of electrochemical batteries such as lithium-ion batteries.

### BACKGROUND OF THE DISCLOSURE

Beams of laser-radiation are increasingly used for cutting, drilling, welding, marking, and scribing workpieces made of a wide range of materials; including metals and metal alloys. Traditional mechanical processing produces unwanted defects, such as micro-cracks that may propagate when a processed workpiece is stressed, thereby degrading and weakening the processed workpiece. Laser processing minimizes such unwanted defects, is generally cleaner, and causes a smaller heat-affected zone. Laser machining uses a focused laser beam to produce precise cuts and holes, having high quality edges and walls, while minimizing the formation of unwanted defects.

In laser welding, a focused laser beam locates each weld spot or seam precisely, while minimizing collateral heating. It is useful to distinguish two main laser welding regimes. Conduction welding occurs at lower laser powers and lower power densities. Absorbed laser power heats the irradiated material, melting material in each part to be joined, which flows, mixes, and then solidifies. Keyhole welding occurs at higher laser powers and higher power densities that are sufficient to vaporize some of the irradiated material. Pressure of the vaporized material on surrounding melted material opens a channel through the melted material, having a characteristic narrow and deep profile, which allows deep penetration of the laser beam. Finished keyhole welds are generally narrower, deeper, and stronger than conduction welds.

Lithium ion batteries are the critical enabling technology for portable electronic devices, electric vehicles, and most other contemporary rechargeable electrical devices. Each cell of a battery includes two stacks of thin metal foils that are immersed in or coated with an electrolyte. The metal is most often aluminum or copper and the foils have a typical thickness of about 10 micrometers (μm). There are typically 20 to 40 individual foils in each foil stack. Foil stacks may be rolled into cylinders or lie flat. The electrolyte contains lithium salt. Each foil stack is electrically connected to a metal tab that protrudes from the cell for electrical connection. Multiple cells are electrically connected to form a battery, in series and/or in parallel, depending on the voltage and current requirements of the electrical device. Multiple batteries may be electrically connected, in series and/or in parallel, to form a battery pack.

The mechanical attachment and electrical connection of each foil in a stack to the respective tab is critical for the integrity, reliability, and performance of the battery. However, joining multiple thin metal foils to a much thicker metal tab is challenging. The completed joint must be strong, durable, and have low electrical resistance. Precision resistance welding is used, but relies on interface resistance for these metals with high electrical conductivity, and the high thermal conductivity of these metals means a lot of current must be applied. Ultrasonic welding is used, but requires mechanical compression of the parts to be joined, which must be joined prior to any assembly. Aluminum has a durable oxide layer that must be broken in such non-laser processes. For these reasons, laser welding has emerged as an attractive alternative, providing precise delivery of power to minimize overall heat accumulation. Keyhole laser welding can form a strong weld through the full thickness of a foil stack and a tab. Some battery designs include additional foil-to-tab joints for attaching and connecting cells within the battery that also benefit from keyhole laser welding.

### SUMMARY OF THE DISCLOSURE

Disclosed herein is a method for laser welding a stack of metal foils to a metal substrate. This method is useful in the manufacture of battery cells, for example lithium ion battery cells, where the method may be used to weld a stack of anode metal foils or a stack of cathode metal foils to a metal tab for electrical connection. The disclosed method is a two-step process that circumvents the difficulties of welding together materials with highly disparate thicknesses in a single laser-welding operation. The disclosed method is specifically tailored to laser weld a metal foil stack to only a single metal substrate so as to minimize the form factor of the resulting welded structure.

During laser welding, the metal foil stack is secured between the metal substrate, to which the metal foils are to be connected, and a removable clamp. The metal foil stack is welded only to the metal substrate and not to the clamp, such that the clamp may be removed from the welded structure. In order to avoid welding of the metal foil stack to the clamp, the clamp is set back from the edges of the metal foils.

Laser welding takes place in two steps. First, the metal foils are laser welded to each other in a relatively gentle manner that is commensurate with the relatively thin nature of the metal foils and prevents spatter and excessive curling and/or cracking of the metal foils. This first laser welding step serves to both electrically interconnect the metal foils and structurally strengthen the metal foil stack. Next, benefitting from the improved strength of the welded metal foil stack, more powerful laser welding is used to form a robust and high-quality weld joint that connects the welded metal foil stack to the relatively thick metal substrate. The first laser welding step may rely solely on conduction welding, whereas the second laser welding step may utilize keyhole welding.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a battery cell assembly during manufacturing, according to an embodiment.

FIG. 2 is a flowchart for a method for laser welding a stack of metal foils to a metal substrate, according to an embodiment.

FIGS. 3A-3D illustrate a method for interconnecting a slanted stack of metal foils with an initial laser-weld joint, according to an embodiment.

FIGS. 4A-4C illustrate a method for connecting a stack of metal foils, already interconnected by an initial laser-weld joint, to a metal substrate, according to an embodiment.

FIG. 5 illustrates a repeating two-dimensional scan pattern that may be used in the method of FIGS. 4A-4C.

FIG. 6 illustrates the transverse profile of a composite laser beam that is useful for performing the laser welding of the FIG. 2 method, according to an embodiment.

FIG. 7 illustrates a method for interconnecting a slanted stack of metal foils with an initial laser-weld joint formed by tracing a plurality of transverse paths with a laser beam, according to an embodiment.

FIG. 8 illustrates a no-slant configuration of the stack of metal foils, according to an embodiment.

### DETAILED DESCRIPTION OF THE DISCLOSURE

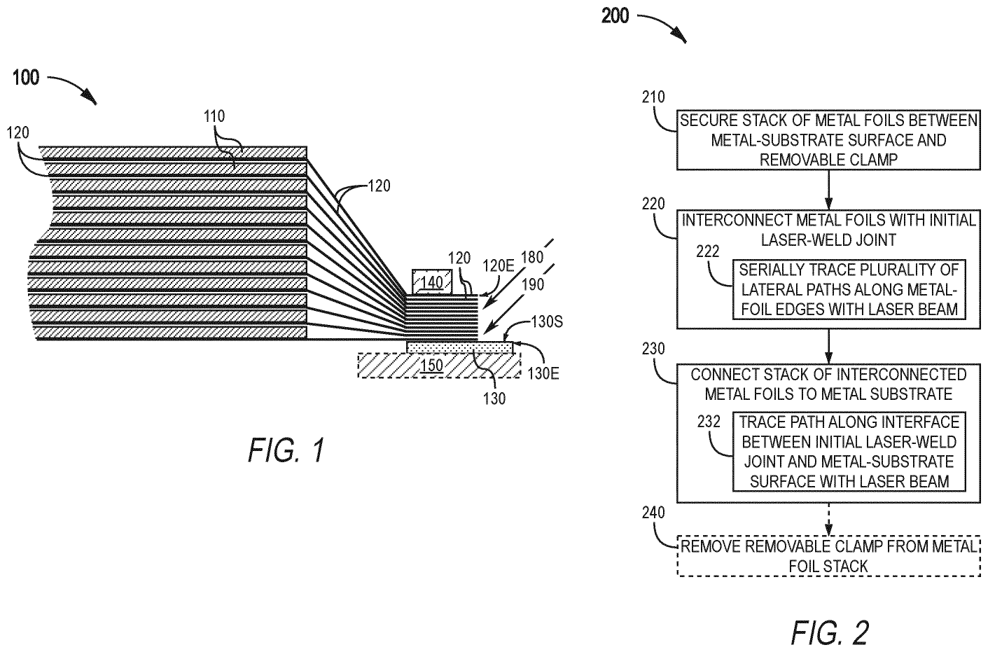

Referring now to the drawings, wherein like components are designated by like numerals, FIG. 1 illustrates, in cross-sectional side view; one battery cell assembly 100 during manufacturing. Assembly 100 includes a plurality of metal foils 120 and material layers 110 disposed thereon. Each material layer 110 includes an electrolyte, for example a lithium salt. Metal foils 120 form either a set of anodes or a set of cathodes of the battery cell. Metal foils 120 may be interleaved with a second set of metal foils, not shown in FIG. 1, with metal foils 120 being anode foils and the second set of metal foils being cathode foils or vice versa. Metal foils 120 extend beyond material layers 110 and reach a metal tab 130. Metal tab 130 is configured to form an electrical contact for metal foils 120. Portions of metal foils 120 are stacked on a surface 130S of metal tab 130 in preparation for laser welding of metal foils 120 to metal tab 130. The thickness of each metal foil 120 may be in the range between 5 and 30 micrometers (μm). For comparison, the thickness of metal tab 130 may be in excess of 0.5 millimeters (mm). Assembly 100 may include 10 or more metal foils 120 stacked on metal-tab surface 130S, for example between 20 and 40 metal foils 120. Metal foils 120 are for example made of aluminum, and metal tab 130 may be made of aluminum or an aluminum alloy. Alternatively, metal tab 130 may be made of another metal or metal alloy, for example copper, a copper alloy, or a steel alloy.

FIG. 2 is a flowchart for one method 200 for laser welding a stack of metal foils to a metal substrate. Method 200 may be applied to battery assembly 100 to laser weld the stack of metal foils 120 to metal tab 130 so as to electrically connect each metal foil 120 to metal tab 130. Method 200 is however also applicable to other scenarios where a stack of metal foils needs to be welded to a metal substrate. Assembly 100 represents just one example of the metal foil stack and metal substrate that may be laser welded by method 200. Without departing from the scope hereof, the stack of metal foils 120 may be a different type of battery-cell metal foils or even a non-battery-related stack of metal foils. Similarly, metal tab 130 may be a metal substrate of a different type of battery assembly or a non-battery-related metal substrate.

Method 200 includes steps 210, 220, and 230. Step 210 secures a stack of metal foils between the surface of a metal substrate and a removable clamp. Step 210 arranges the metal foil stack and the removable clamp such that (a) a side of the metal foil stack is disposed in an interior region of the metal-substrate surface away from its perimeter and (b) the removable clamp is set back from the side of the stack. In one example of step 210, the stack of distal metal foils 120 is secured between metal-tab surface 130S and a removable clamp 140. Edges 120E of metal foils 120 form a side of the stack that is located on an interior portion of metal-tab surface 130S, i.e., a non-zero distance away from the perimeter 130E of metal-tab surface 130S. Removable clamp 140 is set back from the side of the stack formed by edges 120E.

Step 220 is a first laser-welding step that interconnects the metal foils with an initial laser-weld joint. In one example of step 220, a laser beam 180 welds edges 120E of metal foils 120 to each other while the stack of metal foils 120 is secured between metal tab 130 and removable clamp 140. Step 220 includes a step 222 of serially tracing a plurality of lateral paths along the metal-foil edges with a laser beam. Each of the lateral paths is substantially parallel to the metal-foil edges. In one example of step 222, each path traced by laser beam 180 runs parallel to edges 120E, i.e., orthogonal to the plane of FIG. 1.

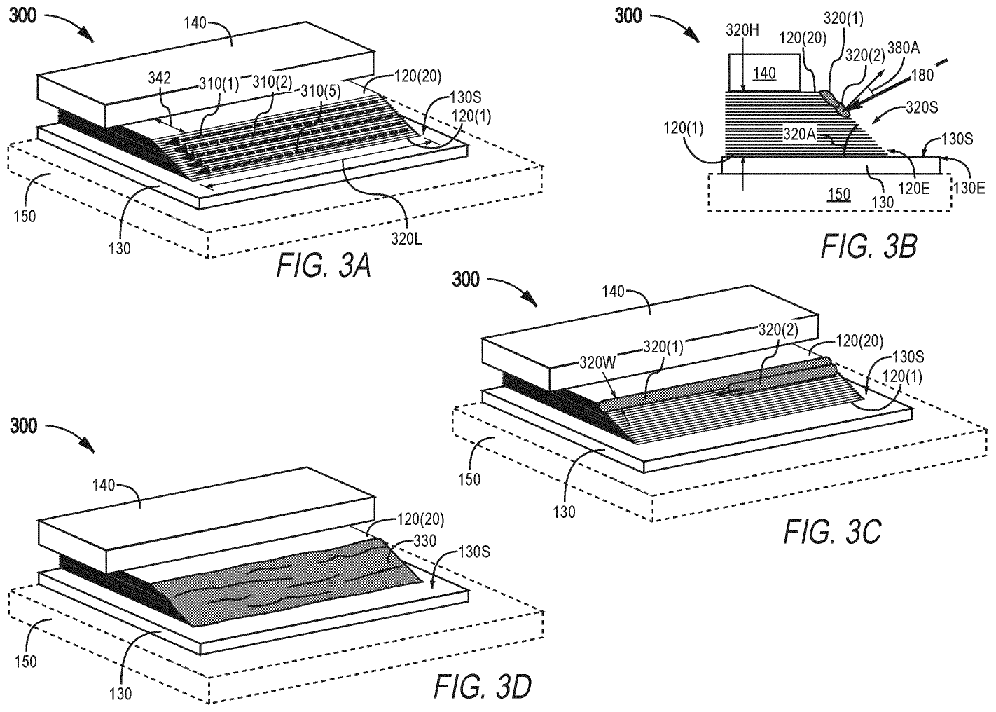

In a top-to-bottom implementation of step 222, the laser beam first traces a path farthest from the metal-substrate surface, and each subsequent lateral path traced by the laser beam is closer to the metal-substrate surface than the preceding lateral path(s) already traced by the laser beam. In one example of this top-to-bottom implementation, laser beam 180 first traces a path that is near the top of the stack of metal foils 120, that is, farthest from metal-tab surface 130S and closest to removable clamp 140. This trace runs parallel to edges 120E, i.e., orthogonal to the plane of FIG. 1. While laser beam 180 traces this first lateral path, laser beam 180 melts edges 120E of two or more uppermost metal foils 120 to weld these together. Next, laser beam 180 traces a lateral path that is closer to metal-tab surface 130S to weld more metal foils 120 to those already welded. This process continues until edges 120E of all metal foils 120 have been welded together in an initial weld joint. One embodiment of the top-to-bottom implementation of step 222 is discussed in further detail below in reference to FIGS. 3A-3D.

Step 220 operates on metal foils that are relatively thin. Step 220 does not attempt to weld these thin metal foils to the thicker metal substrate. Therefore, step 220 may relatively gently weld together the metal foils to avoid undesirable outcomes, such as excessive curling and/or cracking of the metal foils as well as significant loss of material caused by spatter. Step 220 may rely solely on conduction welding to avoid such undesirable outcomes. Once step 220 is completed, the initial laser-weld joint not only electrically interconnects the metal foils but also provides structural strength.

Furthermore, due to the removable clamp being set back from the side of the stack formed by the metal-foils edges, the metal foils are not completely fixed in place before welding. Conduction welding along the series of lateral paths in step 220 is particularly well suited for preventing excessive curling and cracking of the metal foils in this configuration.

In an alternative embodiment, step 220 traces a differently arranged set of paths, for example a plurality of paths transverse to metal foil edges 120E or another set of paths that cooperate to span across all metal edges 120E. This alternative embodiment may utilize conduction welding.

Step 230 is a second laser-welding step that connects the stack of metal foils to the metal substrate. Step 230 benefits from the stack of metal foils having already been interconnected with the initial laser-weld joint in step 220. The structural strength offered by the initial laser-weld joint has at least two benefits. First, it is not necessary to weld through the entire metal foil stack since these are already electrically and structurally interconnected by the initial laser-weld joint formed in step 220. Second, the strength provided by the initial laser-weld joint allows for more powerful welding in step 230 to form a robust and high-quality electrical connection between the metal foils and the metal substrate.

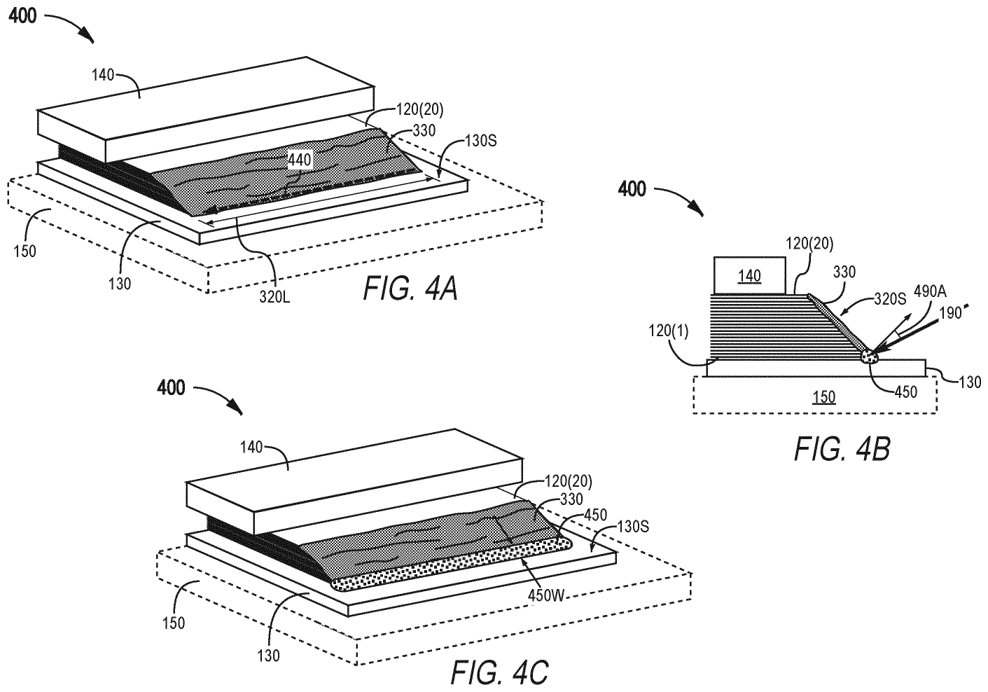

Step 230 includes a step 232 of tracing a path along the interface between the initial laser-weld joint, formed in step 220, and the metal-substrate surface with a laser beam. The laser beam may perform keyhole welding while tracing this path, so as to optimize the quality of the resulting electrical connection. In one example of step 230, implementing step 232, a laser beam 190 traces a path along the interface between metal-tab surface 130S and the initial laser-weld joint interconnecting edges 120E of metal foils 120. The path traced in this example of step 230 may be generally along a direction that is orthogonal to the plane of FIG. 1. One embodiment of step 230 is discussed in further detail below in reference to FIGS. 4A-4C.

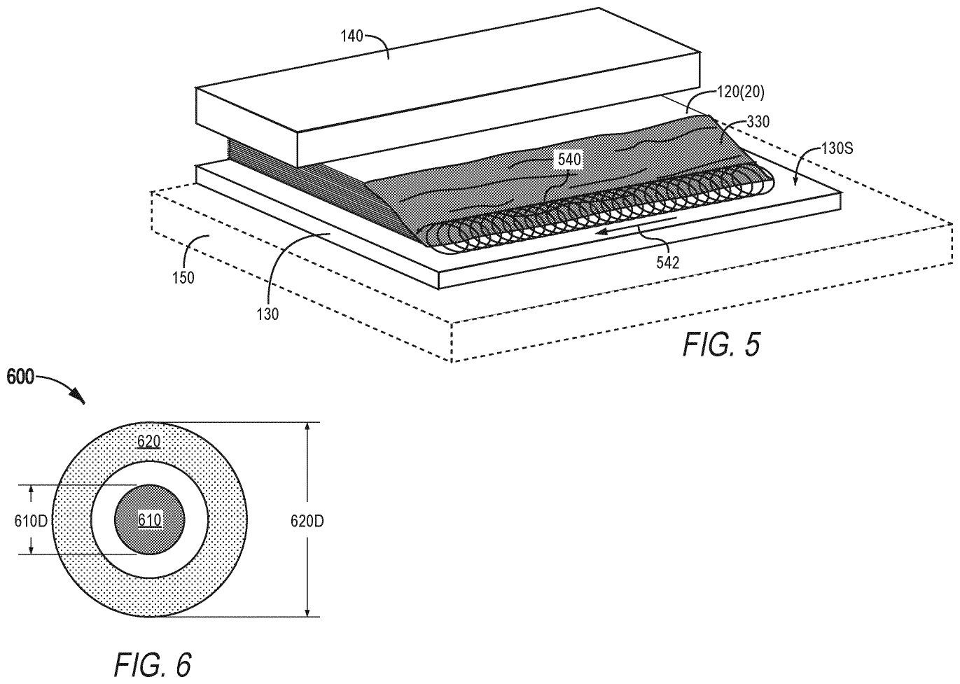

Step 232 may utilize a repeating two-dimensional (2D) scan pattern to optimize keyhole formation and weld quality. The repeating 2D scan pattern may oscillate across the interface in a circular or oval fashion. Welding with a repeating 2D scan pattern is discussed in further detail below in reference to FIG. 5.

Each of steps 220 and 230 may utilize a shield gas, such as argon or another inert gas, in the welding region.

Method 200 may further include a step 240 of removing the removable clamp from the metal foil stack after completion of the two laser-welding steps 220 and 230. Since neither step 220 nor step 230 welds the removable clamp to the metal foil stack, step 240 may remove the clamp simply by displacing the clamp from the metal foil stack. In certain embodiments of method 200, step 210 clamps the metal substrate and the stack of metal foils between the removable clamp and a backing plate, for example a backing plate 150 as shown in FIG. 1. In such embodiments, step 240 may displace the removable clamp from the backing plate to facilitate extraction of the metal substrate and the stack of metal foils (as welded together by steps 220 and 230).

We have found that it is advantageous to arrange the metal foils in step 210 such that the side of the metal stack, formed by the metal-foil edges, is slanted in the direction toward the removable clamp. In other words, it is advantageous to offset the metal foil edges from each other such that the side of the metal stack, to be laser welded, faces somewhat away from the metal-substrate surface. This configuration allows for the laser beam, in both step 220) and 230, to be incident along a direction that is at an oblique angle with respect to the metal-substrate surface, for example approximately normal to the side of the metal stack. The slanted configuration also increases the area accessible for laser welding in step 220, thus allowing for the formation of a stronger laser-weld joint. Furthermore, laser welding of the metal foil edges in this configuration handles shrinkage of the metal foils particularly well.

FIGS. 3A-3D illustrate one method 300 for interconnecting such a slanted stack of metal foils with an initial laser-weld joint. Method 300 is an embodiment of step 220 and may be applied to the stack of metal foils 120 in one embodiment of assembly 100 where the stack has a slanted side. The example depicted in FIGS. 3A-3D has 20 metal foils 120, enumerated 120(1) through 120(20), with metal foils 120(1) being closest to metal-tab surface 130S and metal foils 120(20) being closest to removable clamp 140. Without loss of generality, method 300 will be discussed here in the context of metal foils 120 and metal tab 130. FIG. 3A illustrates one configuration of paths traced by the laser beam in method 300. FIGS. 3B and 3C depict, in cross-sectional side view and in perspective view, respectively, the state of the assembly at one stage during method 300. FIG. 3D depicts the completed initial laser-weld joint formed by method 300. FIGS. 3A-3D are best viewed together in the following description.

Method 300 is applied to an arrangement where edges 120E are offset from each other such that, generally, the higher a metal foil 120 is in the stack, the farther the corresponding edge 120E is set back with respect to edge 120E of the metal foil 120(1). As a result, edges 120E of the stack of metal foils 120 forms a slanted side 320S (see FIG. 3B). Deviations from this offset pattern may exist when placement of metal foils 120 is subject to inaccuracies. However, on average, each edge 120E is set back from the edge 120E of any immediately adjacent lower metal foil 120 by an offset. This offset may be in the range between 20 and 200 μm, as averaged over all the metal foils in the stack. The stack of metal foils 120 may have a height 320H in the range between 1 and 3 mm, and the slant angle 320A of side 320S of the stack (see FIG. 3B) may be in the range between 10 and 80 degrees.

Laser beam 180 may be incident on side 320S at nearly normal incidence. For example, the incidence angle 380A of laser beam, relative to a surface normal of side 380A, may be between −20 degrees and +20 degrees. Near-normal incidence of laser beam 180) onto side 320S of the stack may optimize the coupling of energy from laser beam 180 to metal foils 120.

In method 300, laser beam 180 traces a plurality of lateral paths 310 (see FIG. 3A), for example between 3 and 20 lateral paths 310. Laser beam 180 first traces a lateral path 310(1) farthest from metal-tab surface 130S. Each subsequent lateral path 310 is closer to metal-tab surface 130S than any preceding lateral path 310. A final lateral path 310 (a fifth lateral path 310(5) in the example depicted in FIG. 3A) is closest to metal-tab surface 130S. Each lateral path 310 may span the full length 320L of edges 120E, or a significant fraction thereof. Laser beam 180 may trace each lateral path 310 in the same direction, for example as indicated by the arrows in FIG. 3A, or laser beam 180 may trace some lateral paths 310 in mutually opposite directions. In one example, successive lateral paths 310 are traced in opposite directions, forming an overall continuous trace having a serpentine shape. As indicated in FIGS. 3B and 3C, each tracing of a lateral path 310 by laser beam 180 forms a weld line 320. Each weld line 320 may have a width 320W in the range between 15 and 1000 μm. After formation of a first weld line 320(1), each subsequent weld line 320 touches or overlaps with at least the immediate preceding weld line 320. Thus, upon completion of method 300, all edges 120E have been laser-welded together to form a common initial laser-weld joint 330 as shown in FIG. 3D.

In method 300, laser beam 180 may operate with a power level that causes only conduction welding and avoids keyhole formation. Yet, when heated by laser beam 180, metal foils 120 may undergo some amount of shrinkage. If metal foils 120 were completely fixed in place, such shrinkage could lead to mechanical stress and cracking of metal foils 120. However, in method 300, the side of the stack of metal foils 120 is slanted and removable clamp 140 is set back from edges 120E by a distance 342 (see FIG. 3A), such that metal foils 120 are not completely fixed in place. Metal foils 120 are therefore free to undergo some degree of shrinkage without the shrinkage resulting in cracking. Distance 342 is, for example, in the range between 0.1 and 5 mm.

In an alternative embodiment, laser beam 180 traces paths 310 in a different order, for example with the reverse tracing order starting nearest metal-tab surface 130S with lateral path 310(5) and finishing with lateral path 310(1), or at least partly out of order. Laser beam 180 may even interleave the tracing of different lateral paths 310.

FIGS. 4A-4C illustrate one method 400 for connecting a stack of metal foils, already interconnected by an initial laser-weld joint, to a metal substrate. Method 400 is an embodiment of step 230 of method 200 and may be applied to an assembly wherein the stack of metal foils is slanted. For example, method 400 may be applied to an assembly already laser welded according to method 300. Without loss of generality, method 400 will be discussed here in the context of metal foils 120 and metal tab 130, with metal foils 120 having been interconnected by initial laser-weld joint 330. FIG. 4A illustrates a path traced by the laser beam in method 400. FIGS. 4B and 4C depict, in cross-sectional side view and in perspective view, respectively, the state of the assembly upon completion of method 400. FIG. 4B further indicates the propagation direction of laser beam 190 when performing method 400. FIGS. 4A-4C are best viewed together in the following description.

In method 400, laser beam 190 traces a path 440 along the interface between initial laser-weld joint 330 and metal-tab surface 130S (see FIG. 4A). Path 440 may span the full length 320L of edges 120E, or a significant fraction thereof. The incidence direction of laser beam 190 may be near normal with respect to side 320S of the stack of metal foils 120. For example, the incidence angle 490A of laser beam 190 (with respect to a surface normal of side 320S of the stack of metal foils 120) may be between −20 degrees and +20 degrees (see FIG. 4B). Incidence angle 490A may be similar to incidence angle 380A indicated in FIG. 3B. As laser beam 190 traces path 440, laser beam 190 forms a melt pool that solidifies to a laser-weld joint 450 (see FIGS. 4B and 4C). Laser-weld joint 450 electrically and structurally connects the stack of interconnected metal foils 120 to metal tab 130.

Since the stack of metal foils 120 is already interconnected prior to laser beam 190 performing method 400, laser beam 190 does not need to weld through the entire stack of metal foils 120. It is sufficient to melt a portion of initial laser-weld joint 330 closest to metal-tab surface 130S (and, possibly, immediately adjacent areas of metal foils 120 not melted in method 300). The remaining regions of initial laser-weld joint 330 and the stack of metal foils 120 may be left un-melted by method 400. In one example, the melt pool and resulting laser-weld joint 450 formed by laser beam 190 have a width 450W in the range between 0.1 and 2 mm.

Benefitting from the strength provided by initial laser-weld joint 330, laser beam 190 may perform keyhole welding when tracing path 440, so as to maximize the conductivity between metal foils 120 and metal tab 130 via laser-weld joint 450 as well as maximize the robustness of laser-weld joint 450. For optimal keyhole formation and optimal quality of laser-weld joint 450, laser beam 190 may trace path 440 with a repeating 2D scan pattern.

FIG. 5 illustrates one repeating 2D scan pattern 540 that laser beam 190 may use in method 400. Repeating 2D scan pattern 540 oscillates across the interface between initial laser-weld joint 330 and metal-tab surface 130S in a circular or oval fashion. To trace repeating 2D scan pattern 540, laser beam 190 is directed to loop around a center location while the center location is translated along a linear direction 542.

As an alternative to the oval or circular scan pattern shown in FIG. 5, laser beam 190 may trace a sinusoidal or sawtooth pattern that repeatedly crosses the interface between initial laser-weld joint 330 and metal-tab surface 130S.

FIG. 6 illustrates the transverse profile of one composite laser beam 600 that is useful for performing the laser welding of method 200. Composite laser beam 600 includes a center beam 610 and an annular beam 620. Center beam 610 may have a 1/e2 diameter 610D in the range between 15 and 100 μm. Annular beam 620 may have an outer 1/e2 diameter 620D in the range between 100 and 500 μm. A local minimum in laser power may exist between center beam 610 and annular beam 620. Composite laser beam 600 may be generated by a fiber laser, such as the HighLight™ FL-ARM laser from Coherent, Inc. of Santa Clara, California or as discussed in U.S. Pat. No. 10,807,190 (issued Oct. 20, 2020) incorporated herein by reference in its entirety. Alternatively, the single laser beam generated by a standard fiber laser may be manipulated, e.g., with refractive and/or diffractive optics, to form composite laser beam 600.

In one scenario, composite laser beam 600 performs both step 220 and 230 of method 200, for example according to methods 300 and 400. In step 220, or method 300, the laser source may be operated with no or only insignificant power in center beam 610 and perform conduction welding with annular beam 620 only. Here, the power of annular beam 620 may be in the range between 50 and 300 watts (continuous wave). We have found that this power level and a scanning speed along lateral paths 310 of 100-500 mm/second(s) is suitable for laser welding 15-μm thick aluminum foils according to method 300. In step 230, or method 400, center beam 610 and annular beam 620 may have more equal power, for example with the power in each of center beam 610 and annular beam 620 being in the range between 200 and 1000 watts (continuous wave). We have found that these power levels, together with a linear scan speed along direction 542 of 50-500 mm/s and a loop rate of 200-800 hertz (that is, perform 200-800 loops per second), are suitable for laser welding interconnected 15-μm thick aluminum foils to an aluminum substrate according to method 400.

Without departing from the scope hereof, one or both of steps 220 and 230 may utilize another laser beam profile, such as Gaussian or top-hat laser beam.

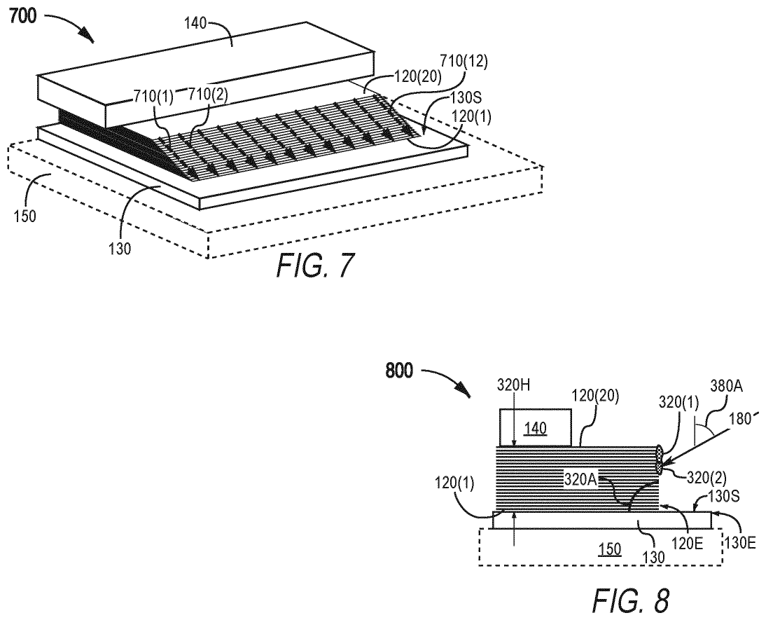

FIG. 7 illustrates one method 700 for interconnecting a slanted stack of metal foils with an initial laser-weld joint formed by tracing a plurality of transverse paths with a laser beam. Method 700 is an embodiment of step 220 and may be applied to the stack of metal foils 120 in one embodiment of assembly 100 where the stack has a slanted side. Method 700 is a modification of method 300, wherein laser beam 180 traces a plurality of transverse paths 710 instead of lateral paths 310. Each transverse path 710 is oriented substantially perpendicular to edges 120E of metal foils 120. Laser beam 180 may trace all transverse paths 710 in the same direction, for example starting from the metal foil 120 most distant from metal-tab surface 130S and tracing in the direction towards metal-tab surface 130S. Alternatively, laser beam 180 may trace some of transverse paths 710 in mutually opposite directions. For example, laser beam 180 may trace transverse paths 710 in a continuous serpentine pattern.

In the example depicted in FIG. 7, laser beam 180 traces 12 transverse paths 710. Without departing from the scope hereof, laser beam 180 may trace a different number of transverse paths 710. The weld lines formed along each transverse path 710 may overlap with weld lines formed along adjacent transverse paths 710, so as to combine and form initial laser weld joint 330 as shown in FIG. 3D.

In an alternative embodiment, transverse paths 710 are at an oblique angle to edges 120E.

Without departing from the scope hereof, each of methods 300, 400, and 700 may be modified to be applied to a configuration where the stack of metal foils 120 is not slanted or has only very little slant. FIG. 8 illustrates such a no-slant configuration of the stack of metal foils 120. Here, there is little or no offset between edges 120E of metal foils 120. For example, the offset may be in the range between 0 and 20 μm. As a result, the side of the stack of metal foils 120 is essentially perpendicular to metal-tab surface 130S, corresponding to slant angle 320A being 90 degrees, or between 80 and 90 degrees.

The present invention is described above in terms of a preferred embodiment and other embodiments. The invention is not limited, however, to the embodiments described and depicted herein. Rather, the invention is limited only by the claims appended hereto.

What is claimed is:

1. A method for laser welding a stack of metal foils to a metal substrate, comprising the steps of:
securing the stack of metal foils between a surface of the metal substrate and a removable clamp such that a side of the stack, formed by edges of the metal foils, is located on an interior portion of the metal-substrate surface, and the removable clamp is set back from the side of the stack;
interconnecting the metal foils with an initial laser-weld joint, the interconnecting step including serially tracing a plurality of lateral paths along the metal-foil edges with a laser beam; and
connecting the stack of interconnected metal foils to the metal substrate by tracing, with a laser beam, a path along the interface between the initial laser-weld joint and the metal-substrate surface.

2. The method of claim 1, wherein each of the lateral paths, when being traced, is closer to the metal-substrate surface than any preceding one of the lateral paths.

3. The method of claim 1, further comprising displacing the removable clamp from the stack of metal foils after the connecting step.

4. The method of claim 1, wherein:
the securing step includes clamping the metal substrate and the stack of metal foils between the removable clamp and a backing plate; and
the method further comprises, after the connecting step, displacing the removable clamp from the backing plate to facilitate extraction of the metal substrate and the stack of metal foils as welded together by the interconnecting and connecting steps.

5. The method of claim 1, wherein each tracing of a lateral path in the interconnecting step produces a weld line, and wherein weld lines produced by pairs of adjacent lateral paths overlap spatially.

6. The method of claim 1, wherein the connecting step includes melting a portion of the initial laser-weld joint closest to the metal-substrate surface without melting a portion of the initial laser-weld joint farthest from the metal-substrate surface.

7. The method of claim 1, wherein the laser beam in the connecting step scans a repeating two-dimensional scan pattern along the interface.

8. The method of claim 7, wherein the path traced by the laser beam in the connecting step oscillates across the interface in a circular or oval fashion.

9. The method of claim 1, wherein:
the laser beam in the interconnecting step forms the initial laser-weld joint by conduction welding; and
the connecting step includes keyhole welding the stack of interconnected metal foils to the metal substrate.

10. The method of claim 9, wherein the laser beam in the interconnecting step is an annular laser beam.

11. The method of claim 9, wherein the laser beam in the connecting step includes a central laser beam and an annular laser beam.

12. The method of claim 1, wherein:
the securing step includes offsetting the metal-foil edges from each other such that the side of the stack is slanted in the direction toward the removable clamp; and
the laser beam in each of the interconnecting and connecting steps is incident along a direction that is at an oblique angle with respect to the metal-substrate surface.

13. The method of claim 12, wherein thickness of each of the metal foils is between 5 and 30 micrometers, and wherein the securing step produces an average offset, between the edges of each pair of adjacent metal foils, in the range between 20 and 200 micrometers, as averaged over the stack.

14. The method of claim 13, wherein, in the interconnecting step, each of the lateral paths has a length of at least 5 millimeters and the laser beam has a width in the range between 100 and 500 micrometers.

15. The method of claim 13, wherein the connecting step includes forming a melt pool along the interface, width of the melt pool in dimension transverse to the interface being in the range between 0.1 and 2 millimeters.

16. The method of claim 1, wherein thickness of each of the metal foils is between 5 and 30 micrometers.

17. The method of claim 16, wherein the stack includes at least ten metal foils.

18. The method of claim 16, wherein the metal foils are made of aluminum.

19. The method of claim 18, wherein the metal substrate is made of aluminum or an aluminum alloy.
